(19) United States
(12) Patent Application Publication
(10) Pub. No.: US 2005/0055352 A1
(43) Pub. Date: Mar. 10, 2005

(54) Content directory and synchronization bridge

(75) Inventors: Larry White, San Jose, CA (US); Yun Li, San Jose, CA (US)

Correspondence Address: Jonathan O. Owens;HAVERSTOCK & OWENS LLP, 162 North Wolfe Road, Sunnyvale, CA, 94086, US

(73) Assignee: Sony Corporation

(21) Appl. No.: 10/658,439

(22) Filed: Sep. 8, 2003

(51) Int. Cl. G06F 17/30

(52) U.S. Cl. 707/10

(57) ABSTRACT

An interface layer, also referred to as a synchronization-CDS bridge, automatically provides a first set of update information to a Content Directory Service (CDS) regarding any content received by a first media server during a data synchronization process. The interface layer also provides a second set of update information to a synchronization application regarding any content newly added to the first media server subsequent to a last data synchronization. The interface layer discovers the second set of update information provided to the synchronization application from the CDS. The second set of update information is used by the synchronization application to select the newly added content during a next data synchronization.

### FIELD OF THE INVENTION

The present invention relates to the field of synchronizing data between devices. More particularly, the present invention relates to the field of providing an interface layer used as a software bridge between a synchronization application and a content directory service.

### BACKGROUND OF THE INVENTION

The Universal Plug and Play (UPnP) standard is designed to enable simple and robust connectivity among stand-alone devices and personal computers (PCs) from many different vendors. With UPnP, a device can dynamically join a network, obtain an Internet Protocol (IP) address, convey its capabilities, and learn about the presence and capabilities of other devices. Devices can subsequently communicate with each other directly, thereby enabling discovery and control of devices. UPnP uses standard Transmission Control Protocol/Internet Protocol (TCP/IP) and Internet protocols which facilitates interoperability with existing networks.

The basic building blocks of a UPnP network are devices, services and control points. A UPnP device is a container of services and nested devices. A UPnP device can be, but does not have to be, a physical device. Different categories of UPnP devices are associated with different sets of services and embedded devices. For instance, services within a video cassette recorder (VCR) are different than those within a printer. The set of services provided by a particular device, as well as a list of properties associated with the particular device, are captured in a device description document that the device must host. Preferably, this device description document is written in Extensible Markup Language (XML).

A service exposes actions and models its state with state variables. For instance, as an example, a clock service can be modeled as having a state variable, current_time, which defines the state of the clock, and two actions, set_time and get_time, which enables control of the service. Similar to the device description, this information is part of a service description document preferably written in XML. The UPnP Forum defines UPnP Device and Service Descriptions according to a common architecture. A pointer, such as a Uniform Resource Locator (URL), to each appropriate service description document is included within a device description document. Devices may include multiple services.

A service in a UPnP device includes a state table, a control server and an event server. The state table models the state of the service through state variables and updates them when the state changes. The control server receives action requests, such as set_time, executes the action requests, updates the state table and returns responses. The event server publishes events to interested subscribers anytime the state of the service changes. For instance, a fire alarm service sends an event to interested subscribers when its state changes to “ringing.”

A control point in a UPnP network is a controller capable of discovering and controlling other devices. After discovery of a network device, a control point can retrieve the device description and get a list of associated services, retrieve service descriptions for available services and invoke actions to control the service. The control point can also subscribe to the service's event source such that anytime the state of the service changes, the event server sends an event to the control point.

UPnP uses open, standard protocols such as TCP/IP, HyperText Transport Protocol (HTTP) and XML. Using these standardized protocols aids in ensuring interoperability between vendor implementations. Other technologies can also be used to network devices together. Such technologies include networking technologies such as Home Audio Video Interoperability (HAVi), Consumer Electronic Bus (CEBus), LonWorks, European Installation Bus (EIB), or XI 0. These too can participate in the UPnP network through a UPnP bridge or proxy.

A conventional protocol stack used to implement UPnP is illustrated in FIG. 1. The protocol stack includes a TCP/IP networking protocol stack 10, an HTTP layer 18, an HTTPU (HTTP unicast over User Datagram Protocol (UDP)) layer 20, an HTTPMU (HTTP multicast over UDP) layer 22, an SSDP (Simple Service Discovery Protocol) layer 24, a GENA (General Event Notification Architecture) layer 26, a SOAP (Simple Object Access Protocol) layer 28, a UPnP Device Architecture Defined layer 30, a UPnP Forum Working Committee Defined layer 32 and a UPnP Vendor Defined layer 34. The TCP/IP protocol stack 10 includes an IP layer 16, a TCP layer 14 and a UDP layer 12. The TCP/IP networking protocol stack 10 serves as the base on which the rest of the UPnP protocols are built. By using the standard, prevalent TCP/IP protocol suite, UPnP leverages the protocol's ability to span different physical media and ensures multiple vendor interoperability. UPnP devices can use many of the protocols in the TCP/IP protocol suite including TCP, UDP, IGMP (Internet Group Multicast Protocol), ARP (Address Resolution Protocol) and IP, as well as TCP/IP services such as DHCP (Dynamic Host Configuration Protocol) and DNS (Domain Name System). TCP/IP provides the base protocol stack for network connectivity between UPnP devices.

All aspects of UPnP build on top of HTTP or its variants. HTTPU and HTTPMU are variants of HTTP defined to deliver messages on top of UDP/IP instead of TCP/IP. HTTPU and HTTPMU are protocols used by SSDP, which is described below. The basic message format used by HTTPU and HTTPMU adheres with that of HTTP and is required both for multicast communication and when message delivery does not require the overhead associated with reliability.

SSDP provides a mechanism for discovering network devices on the network. SSDP is built on HTTPU and HTTPMU and defines methods both for a control point to locate resources on the network, and for devices to announce their availability on the network. By defining the use of both search requests and presence announcements, SSDP eliminates the overhead that would be necessary if only one of these mechanisms is used. As a result, every control point on the network has complete information on network state while keeping network traffic low.

Both control points and devices use SSDP. A UPnP control point, upon booting up, can send a multicast SSDP search request over HTTPMU to discover devices that are available on the network. The control point can refine the search to find only devices of a particular type, such as a VCR, particular services, such as devices with clock services, or even a particular device. UPnP devices listen to the multicast port. Upon receiving a search request, the device examines the search criteria to determine if they match. If a match is found, a unicast SSDP over HTTPU response is sent to the control point. Similarly, a device, upon being connected to the network, sends out multiple SSDP presence announcements advertising itself.

Both presence announcements and unicast device response messages include a pointer, such as a URL, to the location of the device description document, which has information on the set of properties and services supported by the device.

The process involved in UPnP networking includes addressing, discovery, description, control, eventing and presentation. UPnP provides support for communication between control points and devices. The network media, the TCP/IP protocol suite and HTTP provide basic network connectivity and addressing. On top, of these open, standard, Internet based protocols, UPnP defines a set of HTTP servers to handle discovery, description, control, events and presentation.

Each device includes a DHCP client that searches for a DHCP server when the device is first connected to the network. If a DHCP server is available, the device uses the IP address assigned to it. If no DHCP server is available, the device uses Auto IP to get an address.

Once devices are attached to the network and addressed appropriately, discovery can take place. Discovery is handled by the SSDP, as discussed above. When a UPnP device is added to the network, SSDP enables the device to advertise its services to control points on the network. When a control point is added to the network, SSDP enables the control point to search for UPnP devices on the network. The fundamental exchange in both cases is a discovery message containing a few, essential specifics about the device or one of its services, for example its type, identifier, and a pointer to its XML device description document.

The next step in UPnP networking is description. After a control point discovers a device, the control point still knows very little about the device. For the control point to learn more about the device and its capabilities, or to interact with the device, the control point must retrieve the device's description from the URL provided by the device in the discovery message.

Devices can include other logical devices and services. The UPnP description for a device is preferably expressed in XML and includes vendor-specific, manufacturer information including the model name and number, serial number, manufacturer name, URLs to vendor-specific Web sites, and so forth. The description also includes a list of any embedded devices or services, as well as URLs for control, eventing and presentation.

After the control point has retrieved a description of the device, the control point has the essentials for device control. To learn more about the service and device, the control point must retrieve a detailed UPnP description for each service. The description for a service is also preferably expressed in XML and includes a list of the commands, or actions, the service responds to, and parameters or arguments, for each action. The description for a service also includes a list of variables. These variables model the state of the service at run time, and are described in terms of their data type, range, and event characteristics.

To control a device, the control point sends an action request to a device's service. To do this, the control point sends a suitable control message to the control URL for the service that is provided in the device description. Control messages are expressed in XML using simple object access protocol (SOAP). In response to the control message, the service returns action specific values or fault codes.

UPnP architecture defines the general interaction between UPnP control points and UPnP network devices containing audio/video (AV) media. The UPnP architecture is independent of any particular device type, content format, and transfer protocol. The UPnP architecture enables a UPnP control point to discover UPnP network devices within a network, and to enumerate the content available on each discovered UPnP network device. Each UPnP network device uses a UPnP Content Directory Service to compile detailed information about each content item on the UPnP network device. Each content item that is referenced by the Content Directory Service includes various information about the content item including the transfer protocol(s) and file format(s) that the UPnP network device storing the content item can use to transfer the content item to another UPnP network device.

In general, a UPnP control point discovers UPnP network devices within a network. This discovery can take place over both wired and wireless networks. The control point interacts with the discovered devices to locate desired content. Once the content is identified, the control point identifies a common transfer protocol and data format that can be used to transfer the content from the UPnP network device on which the content is located and a UPnP network device to which the content is to be rendered. After these transfer parameters are established, the control point controls the flow of content. The actual transfer of the content is performed directly by the two UPnP network devices, the media server and the renderer. The content transfer happens independently from the control point and does not involve the UPnP protocol. The control point uses UPnP to initialize the transfer of the content, but the transfer is performed using an appropriate transfer protocol other than UPnP, including but not limited to HTTP, RTP/RTSP and IEEE 1394.

The Content Directory Service provides a lookup and storage service that allows control points to locate individual objects that the device is capable of providing. For example, the Content Directory Service is used to enumerate a list of songs stored on an MP3 player, a list of still-images comprising various slide-shows, a list of movies stored in a DVD-Jukebox, a list of television shows currently being broadcast and the like. Nearly any type of content can be enumerated using the Content Directory Service.

The Content Directory Service defines a class system to represent the different types of objects that are managed by the Content Directory Service. The class hierarchy of the Content Directory Service is used to type all objects that can be retrieved from the Content Directory Service. The base class, from which all other classes are derived, is referred to as an object. A class is used to assign a type to an object, and identifies the minimum required and optional set of properties that must be present on that object. Classes are organized in a hierarchy with certain classes being derived from others as in a typical object oriented system. The object base class is at the root of the class hierarchy. An item is a first-level class if derived directly from an object. An item most often represents a single piece of AV data, such as a CD track, a movie or an audio file. Items may be playable, meaning they have information that can be played on a rendering device. A container is a first-level class derived directly from an object. A container represents a collection of objects. Containers can represent the physical organization of objects or logical collections. Logical collections can have formal definitions of their contents or they can be arbitrary collections. Containers can be either homogeneous, containing objects that are all of the same class, or heterogeneous, containing objects of mixed class. Containers can also contain other containers.

The Content Directory Service is resident on each respective device having content and represents the content stored on the device. When searching for content within a UPNP network, an application must search each device's Content Directory Service until the desired content is located. Once the desired content is located, that content can then be sent from the appropriate source device to the appropriate receiving device.

Data synchronization enables data located in different databases to be kept up-to-date, so that each data repository contains the same information. Data in a handheld device or laptop often requires synchronization with a desktop machine or a server. When the same data resides in multiple locations, it is often required that the data be routinely synchronized.

Synchronization applications enable devices to perform various forms of data synchronization. Synchronization applications can be used to distribute data from one device to one or more other devices, or to upload data to a device from one or more devices. As part of the data synchronization process, synchronization applications provide communications between devices which are synchronizing data. Such communications can include initialization, control commands, acknowledgments, data transfers, and other synchronization communications necessary to perform data synchronization. Various synchronization protocols exist to enable synchronization communications between data synchronizing devices. Examples of such synchronization protocols include SyncML (Synchronization Markup Language), ICE (Information and Content Exchange), and WebDAV (Web Distributed Authoring and Versioning).

Media files that are added to a server during synchronization, or obtained in another manner, from another server are not organized, such as in a content directory. The UPnP Content Directory Service is designed to provide a UPnP-enabled client access to a UPnP-enabled server, as in a client-server relationship, where the UPnP-enabled client is coupled to the UPnP-enabled server to access data using the UPnP Content Directory Service. The UPnP Content Directory Service is not designed to automatically provide service to content received during data synchronization with another server.

### SUMMARY OF THE INVENTION

An interface layer, also referred to herein as a synchronization-CDS bridge, automatically provides a first set of update information to a Content Directory Service (CDS) regarding any content received by a first media server during a data synchronization process. The interface layer also provides a second set of update information to a synchronization application regarding any content newly added to the first media server subsequent to a last data synchronization. The interface layer discovers the second set of update information provided to the synchronization application from the CDS. The second set of update information is used by the synchronization application to select the newly added content during a next data synchronization.

In one aspect of the present invention, a media server includes a database to store content data, a synchronization application to perform content data synchronization with an external device, a content directory service to browse the content data stored in the database and to provide information regarding the content data stored in the database, and an interface layer coupled to communicate with the synchronization application and the content directory service to provide update information to the content directory service regarding new content data received by the database from the external device during content data synchronization. The interface layer can provide update information to the synchronization application regarding new content added to the database, the new content data to be synchronized with the external device during a next content data synchronization. The external device can be a second media server. The external device can include an internet service. The media server can be a Universal Plug and Play enabled device and the content directory service can be a Universal Plug and Play content directory service. The content data can include media files. The content data can include audio, video, graphic, and text data.

In another aspect of the present invention, a media server includes a database to store content data, a synchronization application to perform content data synchronization with an external device, a content directory service to browse the content data stored in the database and to provide information regarding the content data stored in the database, and an interface layer coupled to communicate with the synchronization application and the content directory service to provide update information to the synchronization application regarding new content added to the database, wherein the new content data is synchronized with the external device during a next content data synchronization. The interface layer can provide update information to the content directory service regarding new content data received by the database from the external device during content data synchronization. The external device can be a second media server. The external device can include an internet service. The media server can be a Universal Plug and Play enabled device and the content directory service can be a Universal Plug and Play content directory service. The content data can include media files. The content data can include audio, video, graphic, and text data.

In yet another aspect of the present invention, a media server includes a database to store content data, a synchronization application to perform content data synchronization with an external device, a content directory service to browse the content data stored in the database and to provide information regarding the content data stored in the database, and an interface layer coupled to communicate with the synchronization application and the content directory service to provide first update information to the content directory service regarding new content data received by the database from the external device during content data synchronization, and to provide second update information to the synchronization application regarding new content added to the database, wherein the new content data is synchronized with the external device during a next content data synchronization. The external device can be a second media server. The external device can include an internet service. The media server can be a Universal Plug and Play enabled device and the content directory service can be a Universal Plug and Play content directory service. The content data can include media files. The content data can include audio, video, graphic, and text data.

In still yet another aspect of the present invention, a network of devices includes a network device, a first media server coupled to the network device, the first media server including a database to store content data, a synchronization application to perform content data synchronization with the network device, a content directory service to browse the content data stored in the database and to provide information regarding the content data stored in the database, and an interface layer coupled to communicate with the synchronization application and the content directory service to provide first update information to the content directory service regarding new content data received by the database from the network device during content data synchronization, and to provide second update information to the synchronization application regarding new content added to the database, wherein the new content data is synchronized with the network device during a next content data synchronization. The external device can be a second media server. The external device can include an internet service. The media server can be a Universal Plug and Play enabled device and the content directory service can be a Universal Plug and Play content directory service. The content data can include media files. The content data can include audio, video, graphic, and text data.

In another aspect of the present invention, a method of synchronizing data between two network devices includes sending first update information to a content directory service from an interface layer regarding a first new content data received by a first media device from a second media device during content data synchronization performed by a synchronization application, and sending second update information to the synchronization application from the interface layer regarding a second new content added to the first media device, wherein the second new content data is synchronized with the second media device during a next content data synchronization. The first media server can be a Universal Plug and Play enabled device and the content directory service can be a Universal Plug and Play content directory service. The content data can include media files. The content data can include audio, video, graphic, and text data. Sending the first update information to the content directory service and sending the second update information to the synchronization application can be performed automatically.

In yet another aspect of the present invention, a method of synchronizing data between two network devices includes performing data synchronization between a first media server and a second media server, receiving content data related to the data synchronization on the first media server, obtaining update information related to the received content data from a synchronization application on the first media server, providing the update information to a content directory service of the first media server, and updating the content directory service according to the update information. The method can also include obtaining additional update information from a database within the first media server, wherein additional update information corresponds to new content data added to the database. The method can also include providing the additional update information to the synchronization application such that the new content data is synchronized with the second media device during a next data synchronization. The first media server can be a Universal Plug and Play enabled device and the content directory service can be a Universal Plug and Play content directory service. The content data can include media files. The content data can include audio, video, graphic, and text data.

### BRIEF DESCRIPTION OF THE DRAWINGS

FIG. 1 illustrates a conventional protocol stack used to implement the Universal Plug and Play standard.

FIG. 2 illustrates an exemplary network of devices.

FIG. 3 illustrates a block diagram of an exemplary hardware system resident in each network device implementing the synchronization-CDS bridge of the present invention.

FIG. 4 illustrates a protocol according to the present invention.

FIG. 5 illustrates a preferred method of updating a content directory service (CDS) using an interface layer of the present invention.

FIG. 6 illustrates a preferred method of updating the first synchronization application using the interface layer of the present invention.

### DETAILED DESCRIPTION OF THE EMBODIMENTS

Embodiments of the present invention include an interface layer, or a synchronization-CDS bridge, to automatically provide a first set of update information to a Content Directory Service (CDS) regarding any content received by a first media server during a data synchronization process. The interface layer also provides a second set of update information to a synchronization application regarding any content newly added to the first media server subsequent to a last data synchronization. The interface layer discovers the second set of update information provided to the synchronization application from the CDS. The second set of update information is used by the synchronization application to select the added content during a next data synchronization. The interface layer automatically provides the first set of update information to the CDS and the second set of update information to the synchronization application, without user intervention. The interface layer, the synchronization application, and the CDS are preferably included within the first media server. Data synchronization is performed between the first media server and another network device, preferably a second media server. Alternatively, the other network device is a web site including an internet service. Although the first media server and the CDS can be of any conventional type, the first media server is preferably UPnP enabled and the CDS is preferably a UPnP CDS.

The term “content” as used herein preferably refers to media files, such as audio, video, graphics, and any combination thereof. Alternatively, content can include any type of data including media files, email, address books, text files, and data files.

The CDS on the first media server acts as a user's directory that lists available content on the first media server. Each time the first media server synchronizes data with another network device and new content is loaded onto the first media server, the CDS is updated by the interface layer to indicate the inclusion of the new content. If the CDS is not updated, the CDS would not indicate that the new content exists, and a user browsing the CDS would not know the new content is available.

Each time new content is loaded onto the first media server independent of a data synchronization, the synchronization application is updated by the interface layer to indicate that new content has been added to the first media server. The synchronization application uses this update information during a subsequent data synchronization to know what new content to transfer from the first media server and where to locate the new content on the first media server.

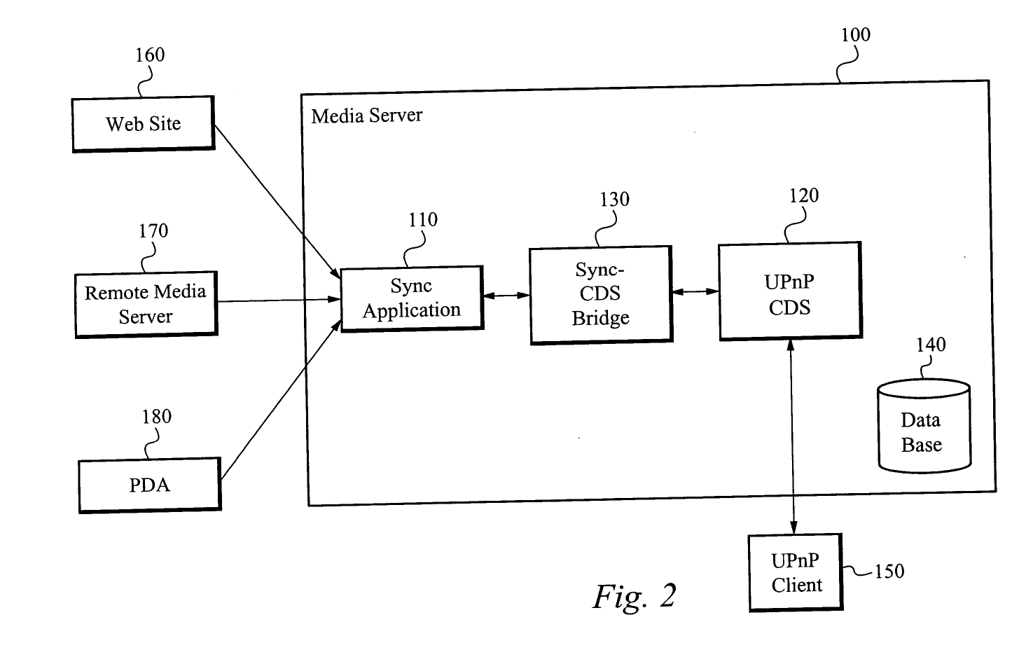

FIG. 2 illustrates an exemplary network of devices including a first media server 100, a remote media server 170, a web site 160, and a Personal Digital Assistant (PDA) 180. In the preferred embodiment of the present invention, the first media server 100 is a UPnP enabled device. The first media server includes a database 140 to store content. The first media server 100 also includes a CDS 120, a synchronization application 110, and a synchronization-CDS bridge 130. In the preferred embodiment, the CDS 120 is a UPnP CDS. The synchronization-CDS bridge 130 acts as an interface layer between the synchronization application 110 and the CDS 120. The synchronization application 110 can be any conventional synchronization application. The synchronization application 110 preferably provides data synchronization communications using one or more conventional synchronization protocols, including but not limited to SyncML, ICE, and Web DAV. The first media server 100 is coupled to one or more network devices using a conventional communications network such as the internet, corporate intranet, or dedicated network, either wired or wireless. In the exemplary network of devices illustrated in FIG. 2, the first media server 100 is coupled to the web site 160, the remote media server 170, and the PDA 180. It should be clear to those skilled in the art that more or less network devices can be coupled to the first media server 100.

The synchronization application 110 enables a data synchronization process between the first media server 100 and either the web site 160, the remote media server 170, or the PDA 180. In the case where data is synchronized between the first media server 100 and the remote media server 170, the synchronization application 110 provides the synchronization communications sent from the first media server 100 to the remote media server 170, and receives the synchronization communications sent to the first media server 100 from the remote media server 170. During the data synchronization process, new content is received from the remote media server 170 by the first media server 100, and the new content is stored in the database 140 within the first media server 100. As the new content is received by the database 140, the synchronization application 110 keeps a record of the new content received. The synchronization-CDS bridge 130 searches the synchronization application 110 for any newly added content sent to the database 140. Information related to any new content discovered by the synchronization-CDS bridge 130 is sent by the synchronization-CDS bridge 130 to the CDS 120 as update information. The CDS 120 is updated according to the update information received from the synchronization-CDS bridge 130, so that the CDS 120 accurately reflects all content in the database 140, including the newly added content, subsequent to the data synchronization. Data synchronization between the first media server 100 and the web site 160, and between the first media server 100 and the PDA 180 is performed in a similar manner as described above.

In the preferred embodiment, the synchronization-CDS bridge 130 searches the synchronization application 110 for any newly added media files. The synchronization-CDS bridge 130 writes a script to call UPnP “ContentDirectory”. The script preferably includes SOAP commands “CreateObject”, “ImportResource”, and “UpdateResource”, to add a reference for each discovered media file to the ContentDirectory on the UPnP CDS 120.

In an alternative embodiment, a synchronization protocol, e.g. SyncML or ICE, used in the data synchronization process acts as a service of the UPnP CDS 120. In this manner, the data synchronization process, including receiving new content by the first media server 100, is tightly integrated with the UPnP CDS 120.

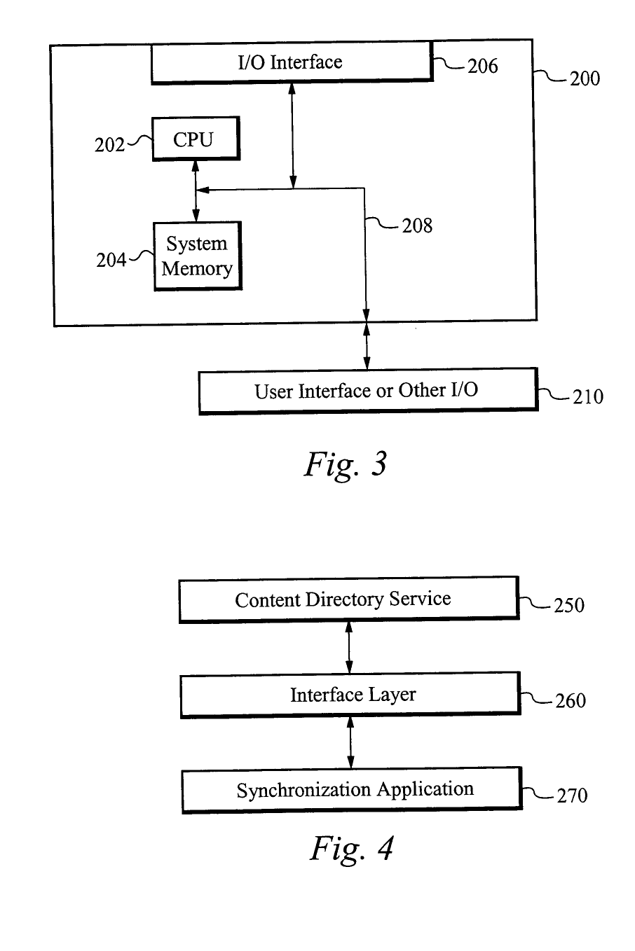

A block diagram of an exemplary hardware system resident in each network device implementing the synchronization-CDS bridge of the present invention is illustrated in FIG. 3. In the hardware system illustrated in FIG. 3, a printed circuit board 200 is coupled to a user interface 210. The printed circuit board 200 includes a central processing unit (CPU) 202 coupled to system memory 204 and to an I/O bus interface 206 by a system bus 208. The user interface 210 is also coupled to the system bus 208. The user interface 210 is network device specific, but can include a keyboard, display or other I/O devices for communicating with a user of the network device. It should be apparent to those skilled in the art that there may be some devices implementing the synchronization-CDS bridge of the present invention which do not include the user interface 210, such as a hard disk drive or similar device.

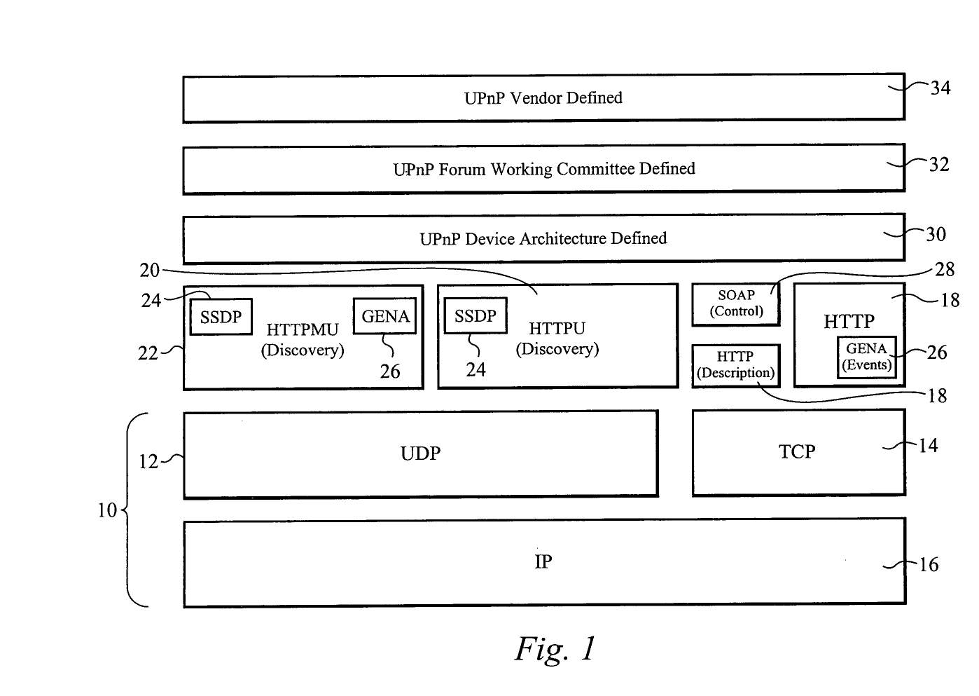

Each network device intending to implement the synchronization-CDS bridge of the present invention will preferably include a hardware system such as the system illustrated in FIG. 3. As applied to the network of devices illustrated in FIG. 1, the media server 100 preferably includes the hardware system of FIG. 3. The CPU 202 within the media server 100 is used to execute the appropriate program instructions. The synchronization-CDS bridge of the present invention will then provide a simplified interface between the synchronization application and the content directory service resident within the media server 100 for providing update information related to data synchronization between network devices.

A protocol according to the present invention is illustrated in FIG. 4. An interface layer 260 is coupled to a synchronization application 270 to provide synchronization communications between two network devices, preferably two media servers. The interface layer 260 is also coupled to communicate with a content directory service (CDS) 250. The CDS 250 provides a lookup and storage service that enables a user to locate, and possibly store, individual data objects, such as songs, movies, pictures, or text, that are stored on the first media server. The synchronization application 270 preferably communicates with a second media server using a supported protocol stack used in the data synchronization process. The synchronization application 270, the interface layer 260, and the CDS 250 are preferably resident within each network device implementing the synchronization-CDS bridge of the present invention. The interface layer 260 communicates with the synchronization application 270 and the CDS 250 as necessary to provide update information regarding newly added content to the first media server.

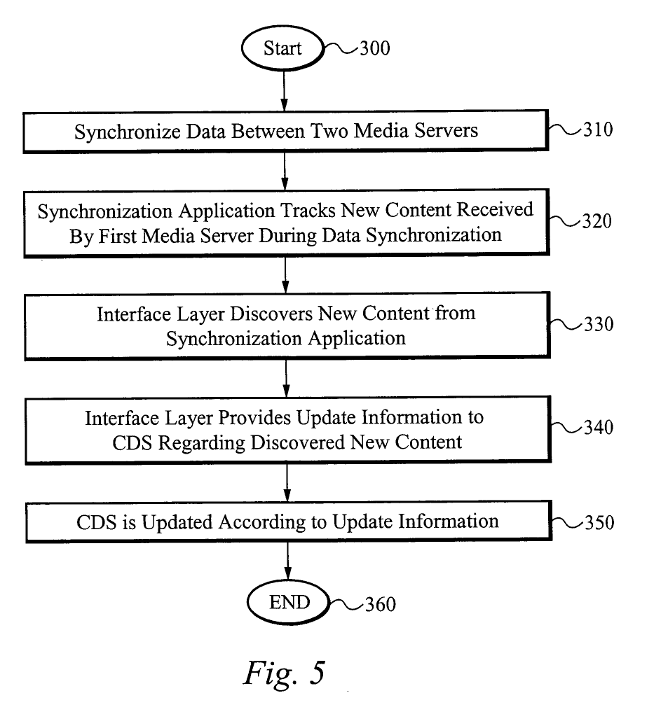

FIG. 5 illustrates a preferred method of updating a content directory service (CDS) using an interface layer of the present invention. The method of updating the CDS starts at the step 300. At the step 310 a data synchronization process is performed in which data is synchronized between a first media server and a second media server. The data synchronization process is executed by a first synchronization application, preferably loaded on the first media server. The first synchronization application sends synchronization communication directed from the first media server to the second media server, and receives synchronization communications from the second media server. A second synchronization application is preferably loaded on the second media application to execute synchronization communications sent from and directed to the second media server. The data synchronization process synchronizes content between the first media server and the second media server in a manner that is well known in the art. For simplicity, the remainder of the preferred method of updating the CDS is described in relation to the first media server. It should be understood that the described process of updating the CDS can also be applied to the second media server.

At the step 320, the first synchronization application tracks all new content that is received by the first media server from the second media server during the data synchronization process. In other words, the first synchronization application keeps a record of the new content loaded into a database of the first media server during data synchronization with the second media server. At the step 330, the interface layer on the first media server discovers the new content from the first synchronization application. Discovery of the new content includes obtaining all related information tracked by the first synchronization application. In this manner, the interface layer discovers the new content loaded into the database during data synchronization.

At the step 340, the interface layer provides the discovered information, referred to as update information, to the CDS on the first media server. In the step 350 the CDS is updated according to the update information received from the interface layer. Once updated, the CDS includes directory information related to the new content received by the first media server during the data synchronization process with the second media server. The preferred process of updating the CDS using the interface layer of the present invention ends at the step 360.

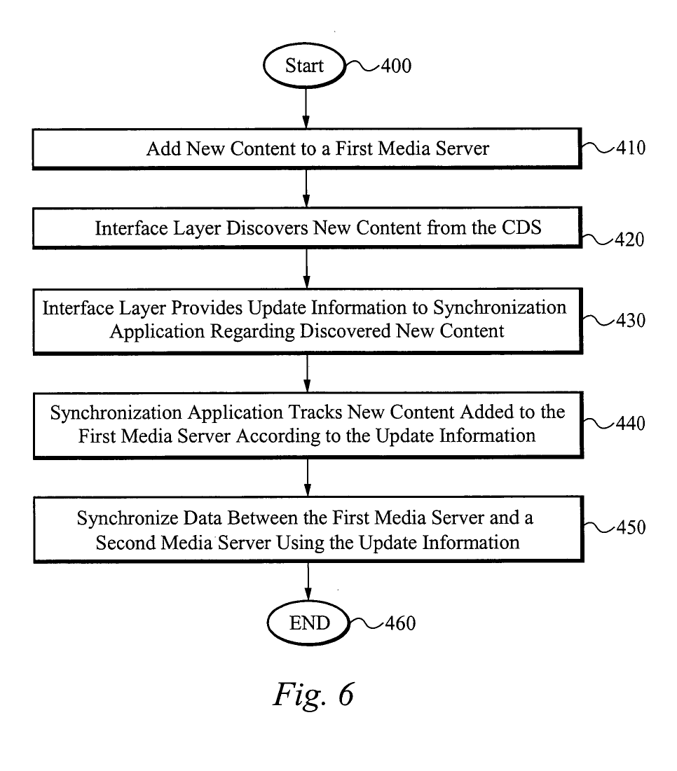

FIG. 6 illustrates a preferred method of updating the first synchronization application using the interface layer of the present invention. The method of updating the first synchronization application starts at the step 400. At the step 410 new content is added to the data base of the first media server. As used herein, the term “new content” refers to either content that is newly loaded onto the database as part of a non-data synchronization process, for example transferring content from a floppy disk to the database, or “new content” refers to content received from the second media server during a data synchronization process, such as the process described in relation to FIG. 5. In regard to FIG. 6, “new content” refers to content newly loaded on the database during a non-data synchronization process. Since the CDS provides a directory of content loaded on the database, the CDS is automatically updated when new content is added to the database in this manner.

At the step 420 the interface layer discovers the new content from the CDS. At the step 430 the interface layer provides information related to the discovered content in step 430, also referred to as update information, to the first synchronization application. At the step 440 the first synchronization application tracks the new content added to the first media server at the step 410 according to the update information. By tracking the new content loaded onto the first media server during a non-data synchronization process, the first synchronization application monitors what new content is added to the first media server from the last data synchronization. By monitoring content added after the most recent data synchronization, the first synchronization application provides a record of what content on the first media server should be transferred from the first media server to the second media server during a subsequent data synchronization process. At the step 450, when the subsequent data synchronization process occurs, content is synchronized between the first media server and the second media server according to the update information received by the first synchronization application at the step 430. In this manner, the new content added to the first media server at the step 410, is transferred to the second media server during the subsequent data synchronization process. At the step 460, the preferred method of updating the first synchronization application using the interface layer ends.

In operation, the interface layer of the present invention acts as a bridge between a synchronization application and a content directory service. When new content is added to a first media server, the content directory service associated with the first media server is automatically updated to reflect the addition of the newly added content. However, a synchronization application on the first media server needs to be updated whenever new content is added to the first media server, independent of a data synchronization, so that during a subsequent data synchronization, the synchronization application knows what content on the first media server has been added since the previous data synchronization. Knowing what content has been added enables the synchronization application to properly provide the newly added content to a second media server during the subsequent data synchronization. The interface layer discovers the newly added content on the content directory service and provides this information to the synchronization protocol.

Similarly, during data synchronization between the first media server and the second media server, the synchronization application tracks any new content that is provided by the second media server to the first media server. When new content is added in this manner, the content directory service of the first media device needs to be updated to accurately reflect all content stored on the first media server, including the newly added content from the data synchronization. The interface layer of the present invention discovers the newly added content from the synchronization application and provides this update information to the content directory service. Once the content directory service receives and incorporates the update information, the content directory service accurately provides content information to a user browsing the first media server.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention. Specifically, the data synchronization process described above can be uni-directional or bi-directional.

1. A media server comprising:
a. a database to store content data;
b. a synchronization application to perform content data synchronization with an external device;
c. a content directory service to browse the content data stored in the database and to provide information regarding the content data stored in the database; and
d. an interface layer coupled to communicate with the synchronization application and the content directory service to provide update information to the content directory service regarding new content data received by the database from the external device during content data synchronization.

2. The media server of claim 1 wherein the interface layer provides update information to the synchronization application regarding new content added to the database, the new content data to be synchronized with the external device during a next content data synchronization.

3. The media server of claim 1 wherein the external device is a second media server.

4. The media server of claim 1 wherein the external device includes an internet service.

5. The media server of claim 1 wherein the media server is a Universal Plug and Play enabled device and the content directory service is a Universal Plug and Play content directory service.

6. The media server of claim 1 wherein the content data includes media files.

7. The media server of claim 1 wherein the content data includes audio, video, graphic, and text data.

8. A media server comprising:
a. a database to store content data;
b. a synchronization application to perform content data synchronization with an external device;
c. a content directory service to browse the content data stored in the database and to provide information regarding the content data stored in the database; and
d. an interface layer coupled to communicate with the synchronization application and the content directory service to provide update information to the synchronization application regarding new content added to the database, wherein the new content data is synchronized with the external device during a next content data synchronization.

9. The media server of claim 8 wherein the interface layer provides update information to the content directory service regarding new content data received by the database from the external device during content data synchronization.

10. The media server of claim 8 wherein the external device is a second media server.

11. The media server of claim 8 wherein the external device includes an internet service.

12. The media server of claim 8 wherein the media server is a Universal Plug and Play enabled device and the content directory service is a Universal Plug and Play content directory service.

13. The media server of claim 8 wherein the content data includes media files.

14. The media server of claim 8 wherein the content data includes audio, video, graphic, and text data.

15. A media server comprising:
a. a database to store content data;
b. a synchronization application to perform content data synchronization with an external device;
c. a content directory service to browse the content data stored in the database and to provide information regarding the content data stored in the database; and
d. an interface layer coupled to communicate with the synchronization application and the content directory service to provide first update information to the content directory service regarding new content data received by the database from the external device during content data synchronization, and to provide second update information to the synchronization application regarding new content added to the database, wherein the new content data is synchronized with the external device during a next content data synchronization.

16. The media server of claim 15 wherein the external device is a second media server.

17. The media server of claim 15 wherein the external device includes an internet service.

18. The media server of claim 15 wherein the media server is a Universal Plug and Play enabled device and the content directory service is a Universal Plug and Play content directory service.

19. The media server of claim 15 wherein the content data includes media files.

20. The media server of claim 15 wherein the content data includes audio, video, graphic, and text data.

21. A network of devices comprising:
a. a network device;
b. a first media server coupled to the network device, the first media server including:
i. a database to store content data;
ii. a synchronization application to perform content data synchronization with the network device;
iii. a content directory service to browse the content data stored in the database and to provide information regarding the content data stored in the database; and
iv. an interface layer coupled to communicate with the synchronization application and the content directory service to provide first update information to the content directory service regarding new content data received by the database from the network device during content data synchronization, and to provide second update information to the synchronization application regarding new content added to the database, wherein the new content data is synchronized with the network device during a next content data synchronization.

22. The network of devices of claim 21 wherein the network device is a second media server.

23. The network of devices of claim 21 wherein the network device includes an internet service.

24. The network of devices of claim 21 wherein the first media server is a Universal Plug and Play enabled device and the content directory service is a Universal Plug and Play content directory service.

25. The network of devices of claim 21 wherein the content data includes media files.

26. The network of devices of claim 21 wherein the content data includes audio, video, graphic, and text data.

27. A method of synchronizing data between two network devices, the method comprising:
a. sending first update information to a content directory service from an interface layer regarding a first new content data received by a first media device from a second media device during content data synchronization performed by a synchronization application; and
b. sending second update information to the synchronization application from the interface layer regarding a second new content added to the first media device, wherein the second new content data is synchronized with the second media device during a next content data synchronization.

28. The method of claim 27 wherein the first media server is a Universal Plug and Play enabled device and the content directory service is a Universal Plug and Play content directory service.

29. The media server of claim 27 wherein the content data includes media files.

30. The method of claim 27 wherein content data includes audio, video, graphic, and text data.

31. The method of claim 27 wherein sending the first update information to the content directory service and sending the second update information to the synchronization application are performed automatically.

32. A method of synchronizing data between two network devices, the method comprising:
a. performing data synchronization between a first media server and a second media server;
b. receiving content data related to the data synchronization on the first media server;
c. obtaining update information related to the received content data from a synchronization application on the first media server;
d. providing the update information to a content directory service of the first media server; and
e. updating the content directory service according to the update information.

33. The method of claim 32 further comprising obtaining additional update information from a database within the first media server, wherein additional update information corresponds to new content data added to the database.

34. The method of claim 33 further comprising providing the additional update information to the synchronization application such that the new content data is synchronized with the second media device during a next data synchronization.

35. The method of claim 32 wherein the first media server is a Universal Plug and Play enabled device and the content directory service is a Universal Plug and Play content directory service.

36. The media server of claim 32 wherein the content data includes media files.

37. The method of claim 32 wherein content data includes audio, video, graphic, and text data.

38. An apparatus for synchronizing data between two network devices, the apparatus comprising:
a. means for performing data synchronization between a first media server and a second media server;
b. means for receiving content data related to the data synchronization on the first media server;
c. means for obtaining update information related to the received content data from a synchronization application on the first media server;
d. means for providing the update information to a content directory service of the first media server; and
e. means for updating the content directory service according to the update information.
